(19) United States
(12) Patent Application Publication
(10) Pub. No.: US 2006/0255619 A1
(43) Pub. Date: Nov. 16, 2006

(54) Retractable hard top for a four door vehicle

(76) Inventors: Robert Boyer Dickie, Canton, MI (US); David Lawrence Newkirk, Sterling, MI (US); Troy Donavan Allan, Howell, MI (US); Douglas Chester Carson, Pinckney, MI (US); Robert Brady Mooney, Farmington Hills, MI (US)

Correspondence Address: Mr. Robin W. Asher;Clark Hill, P.L.C., Suite 3500, 500 Woodward Avenue, Detroit, MI, 48226-3435, US

(21) Appl. No.: 11/399,047

(22) Filed: Apr. 6, 2006

Related U.S. Application Data
(60) Provisional application No. 60/681,351, filed on May 16, 2005.

(51) Int. Cl. B60J 7/20

(52) U.S. Cl. 296/107.08

(57) ABSTRACT

A retractable roof assembly is provided for a motor vehicle having a rear storage space behind a rear seat within a passenger compartment. The retractable roof assembly includes a rail assembly including at least one rear rail and at least one front rail pivotally hinged to the rear rail. A plurality of roof panels slidingly engage the rear and front rails for movement between a roof configuration covering the passenger compartment and a stacked configuration exposing the passenger compartment. A rear pillar is disposed rearward of the rear rail and selectively supports at least one of the plurality of roof panels. When the plurality of roof panels is in the stacked configuration, the rail assembly, plurality of roof panels, and rear pillar are movable into the rear storage space behind the rear seat in order to provide a full open air roof for the motor vehicle.

### RELATED APPLICATION

This patent application claims priority to and all the benefits of U.S. Provisional Application No. 60/681,351 filed on May 16, 2005.

### FIELD OF THE INVENTION

The invention relates to a retractable roof for a motor vehicle. More particularly, the invention relates to a retractable roof that is selectively stowed in a rear storage space between a rear seat and a luggage compartment of a motor vehicle.

### DESCRIPTION OF RELATED ART

Retractable roofs allow ventilation and/or sunlight to enter a passenger compartment to provide occupants thereof with added comfort. One well-known type of retractable roof is a sunroof. Sunroofs typically include a closure panel that is movable, either manually or via an electric motor, relative to an opening in the roof. The closure panel is movable between a closed position generally flush with the roof to completely cover the opening, and an open position to allow ventilation and/or sunlight to enter the passenger compartment through the opening. In addition, the closure panel is typically positionable at one of a plurality of partially open positions between the closed and open positions.

Another well-known type of retractable roof is a convertible roof. In such convertible roofs, the entire roof is moved into a rear portion of the motor vehicle to maximize the ventilation and/or sunlight provided to the occupants. Oftentimes, the retracted roof occupies a substantial portion of a luggage compartment of the motor vehicle, which is undesirable due to the resulting loss of available storage space. In other convertible roof approaches, the roof is moved to a vertical position behind either a front or rear seat. In such a case, the retracted roof is visible behind either the front or rear seat, which is undesirable from an aesthetic standpoint.

### SUMMARY OF THE INVENTION

According to one aspect of the invention, a retractable roof assembly is provided for a motor vehicle having a rear storage space behind a rear seat within a passenger compartment. The retractable roof assembly includes a rail assembly having a pair of spaced apart rear rails and a pair of spaced apart front rails pivotally hinged to the respective rear rails. A plurality of roof panels slidingly engage the rear and front rails for movement between an extended configuration and a stacked configuration. A rear pillar is disposed rearward of the rear rails and selectively supports at least one of the plurality of roof panels. When the plurality of roof panels is in the stacked configuration, the rail assembly, the plurality of roof panels, and the rear pillar are movable into the rear storage space behind the rear seat to provide an open air roof for the motor vehicle.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a rear, perspective view of a motor vehicle including a retractable roof assembly according to the invention in a closed position;

FIG. 2 is a rear, perspective view of the motor vehicle including front and middle panels of the retractable roof assembly stacked underneath a rear panel thereof;

FIG. 3 is a rear, perspective view of the motor vehicle including a front rail folded on top of a rear rail along each side of the motor vehicle while a rear component assembly is in a retracted position;

FIG. 4 is a rear, perspective view of the motor vehicle including the retractable roof assembly in a fully retracted position; and

FIG. 5 is a rear, perspective view of the motor vehicle including a decklid in an open position while the retractable roof assembly is in the fully retracted position.

### DETAILED DESCRIPTION OF THE PREFERRED EMBODIMENT

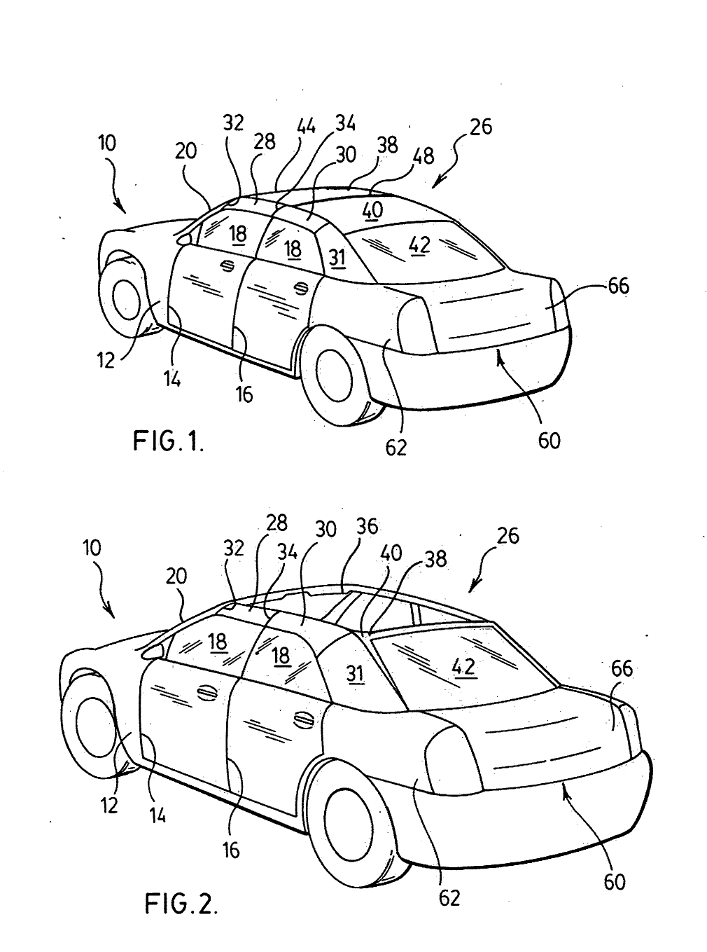

Referring to FIG. 1, a motor vehicle, generally shown at 10, includes a body portion 12 and front 14 and rear 16 doors pivotally hinged to the body portion 12. The front 14 and rear 16 doors each include a movable window pane 18. The body portion 12 includes an “A” pillar 20 along each side of the motor vehicle 10. Although a “B” pillar is not shown, it is contemplated that a “B” pillar may be positioned between the window panes 18 of the front 14 and rear 16 doors along each side of the motor vehicle 10.

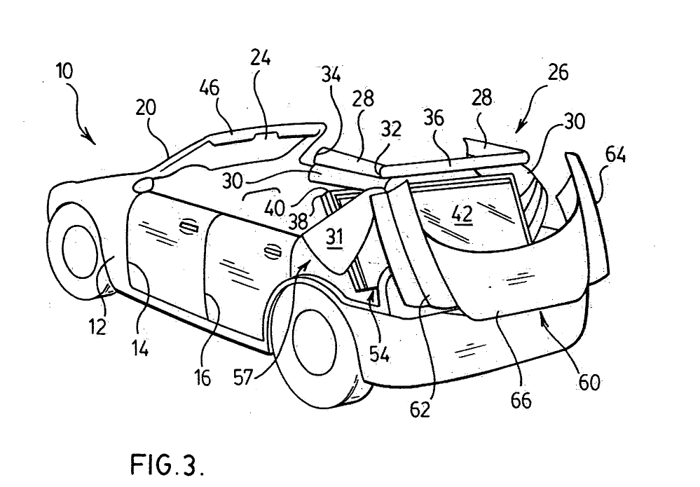

Referring to FIGS. 1 and 2, a retractable roof assembly, generally shown at 26, includes a front rail 28, a rear rail 30, and a movable rear pillar 31 along each side of the motor vehicle 10. Each of the front rails 28 extends between opposing first 32 and second 34 ends. A bow 36 is fixedly secured to and extends between the spaced apart front rails 28 at the first end 32 thereof. The second end 34 of each front rail 28 is pivotally hinged to the rear rail 30. Thus, the front rails 28 are movable between a support position, shown in FIGS. 1 and 2, and a folded position, shown in FIG. 3. In the folded position, the front rails 28 are disposed above the respective rear rails 30. The bow 36 moves with the front rails 28 as the front rails 28 move between the support and folded positions.

Referring back to FIG. 1, the retractable roof assembly 26 also includes a front roof panel 38, a middle roof panel 40, and a rear roof panel 42 slidingly engaging and disposed between the front rails 28 and the rear rails 30. The roof panels 38, 40, 42, which are formed from glass, polycarbonate, or a similar material, provide the motor vehicle 10 with a “hard top.” The front roof panel 38 includes a front edge 44 selectively abutting a header 46 above a front windshield 24, shown in FIG. 3, and an opposing rear edge 48 selectively abutting the middle roof panel 40. The rear roof panel 42 also serves as a rear windshield of the motor vehicle 10.

The roof panels 38, 40, 42 are movable between an extended configuration, shown in FIG. 1, in which the roof panels 38, 40, 42 cover occupants of front 50 and rear 52 seats within a passenger compartment 53 of the motor vehicle 10, and a stacked configuration, shown in FIGS. 2 and 3, for providing ventilation and/or sunlight to the occupants of the front 50 and rear 52 seats. In the extended configuration, the front roof panel 38 is at least partially supported by the bow 36. In the stacked configuration, the front 38 and middle 40 roof panels are tucked underneath the rear roof panel 42 to provide a compact unit that is eventually stored behind the rear seat 52 of the motor vehicle 10. More specifically, the front roof panel 38 is initially raised to a height above that of the middle roof panel 40 and then driven rearwards thereover. As the front roof panel 38 passes over the middle roof panel 40, the front 38 and middle 40 roof panels are coupled to one another and move together towards the rear roof panel 42. The rear roof panel 42 is first raised, which allows the front 38 and middle 40 roof panels to slide underneath the rear roof panel 42, and then lowered to provide the stacked configuration. The mechanism that is utilized to move the roof panels 38, 40, 42 between the extended and stacked configurations is fully disclosed in Applicant's pending PCT patent application serial number PCT/CA04/001919 filed on Nov. 4, 2004, which is incorporated herein by reference in its entirety.

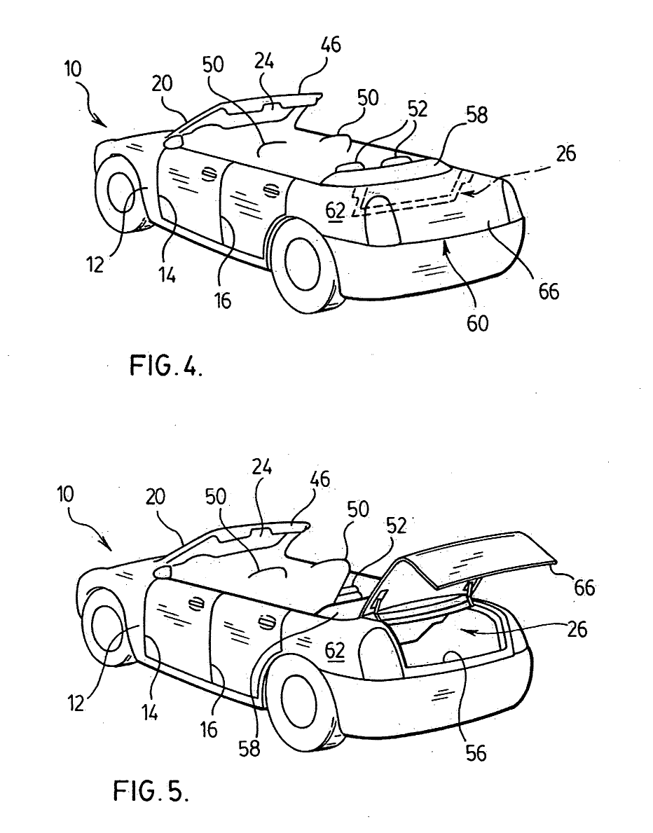

The retractable roof assembly 26 is movable between a closed position, shown in FIG. 1, and a fully open or stowed position, shown in FIGS. 4 and 5. When the retractable roof assembly 26 is in the stowed position, the entire passenger compartment 53 is completely exposed to the elements. The retractable roof assembly 26 may be moved between the closed and stowed positions by the actuator and link assembly disclosed in the above-mentioned PCT patent application serial number PCT/CA04/001919. It is, however, appreciated that the retractable roof assembly 26 may be moved between the closed and stowed positions in any of numerous ways.

The motor vehicle 10 includes a roof storage space 54, shown in FIG. 3, positioned behind a rear seat 52 and in front of a luggage compartment 56, shown in FIG. 5. A rail storage space 57 is disposed adjacent the rear storage space 54 underneath each of a pair of spaced apart rear quarter panels 62, 64. The roof 54 and rail 57 storage spaces house the retractable roof assembly 26, including the front rails 28 and bow 36, the rear rails 30, the rear pillar 31, and the roof panels 38, 40, 42, when the retractable roof assembly 26 is in the stowed position. Advantageously, the positioning of the retractable roof assembly 26 in the rear 54 and rail 57 storage spaces does not decrease the storage capacity of the luggage compartment 56. A rear shelf 58, shown in FIGS. 4 and 5, selectively covers the roof storage space 54 to allow the retractable roof assembly 26 to enter or exit the roof storage space 54.

Referring to FIGS. 3 through 5, a rear component assembly, generally indicated at 60, of the motor vehicle 10 includes the pair of spaced apart rear quarter panels 62, 64 and a decklid 66 selectively coupled thereto. The rear component assembly 60 is movable between a retracted position, shown in FIG. 3, and a closed position, shown in FIG. 4. In the retracted position, the rear quarter panels 62, 64 and decklid 66 pivot together relative to the rear seat 52 to allow the retractable roof assembly 26 to move into the stowed position. Once the retractable roof assembly 26 reaches the stowed position, the rear component assembly 60 returns to the closed position, as shown in FIG. 4. It is appreciated that the pivotal movement of the rear component assembly 60 of the motor vehicle 10 may be achieved in any of numerous ways as is known to those of ordinary skill in the art.

As mentioned above, the decklid 66 is selectively coupled to the rear quarter panels 62, 64. Thus, when an individual desires to access the luggage compartment 56 with the retractable roof assembly 26 in the stowed position, the decklid 66 may be pivoted relative to the rear quarter panels 62, 64, as shown in FIG. 5.

In operation, starting with the retractable roof assembly 26 in the closed position, as shown in FIG. 1, the front roof panel 38 is first raised and driven rearwards over the middle panel 40 into coupling engagement therewith. The coupled front 38 and middle 40 roof panels slide rearwards towards the rear roof panel 42 at the same time that the rear roof panel 42 is being raised. The front 38 and middle 40 panels come to rest underneath the rear roof panel 42 so that the roof panels 38, 40, 42 are in the stacked configuration, shown in FIG. 2. The movable window panes 18 are also opened but this step may occur at any time during the operation. The front rail 32, including the bow 36, pivots relative to the rear rail 34 until the front rail 32 is disposed thereabove, as shown in FIG. 3. Next, the rear component assembly 60 moves into the retracted position, shown in FIG. 3, and the rear shelf 58 moves to expose the rear storage space 54. The retractable roof assembly 26, including the front 32 and rear 34 rails, the roof panels 38, 40, 42, and the rear pillar 31 pivot into the rear storage space 54. Finally, the rear component assembly 60 returns to the closed position and the rear shelf 58 covers the rear storage space 54 to hide the retractable roof assembly 26 from view. As a result, a full open air roof for the motor vehicle 10 is provided.

The invention has been described in an illustrative manner. It is to be understood that the terminology, which has been used, is intended to be in the nature of words of description rather than of limitation. Many modifications and variations of the invention are possible in light of the above teachings. Therefore, within the scope of the appended claims, the invention may be practiced other than as specifically described.

What is claimed:

1. A retractable roof assembly for a motor vehicle having a rear storage space behind a rear seat within a passenger compartment, said retractable roof assembly comprising:
a rail assembly including a pair of spaced apart rear rails and a pair of spaced apart front rails pivotally hinged to said respective pair of rear rails;
a plurality of roof panels slidingly engaging said rear and front rails for movement between an extended configuration covering the passenger compartment and a stacked configuration exposing the passenger compartment; and
a rear pillar disposed rearward of said rear rail and selectively supporting at least one of said plurality of roof panels wherein said rail assembly, said plurality of roof panels, and said rear pillar are movable into the rear storage space behind the rear seat when said plurality of roof panels are in said stacked configuration in order to provide a full open air roof for the motor vehicle.

2. A retractable roof assembly as set forth in claim 1 including a rear component assembly movable between closed and retracted positions for selectively allowing movement of said retractable roof assembly into and out of the rear storage space.

3. A retractable roof assembly as set forth in claim 2 wherein said rear component assembly includes a pair of spaced apart rear quarter panels defining a respective pair of rail storage spaces each laterally outwards of said rear storage space for selectively housing said rail assembly.

4. A retractable roof assembly as set forth in claim 3 including at least one bow extending between said pair of spaced apart front rails for selectively supporting one of said plurality of roof panels.

5. A retractable roof assembly as set forth in claim 4 including a rear shelf selectively covering the rear storage space.
